(19) United States
(12) Patent Application Publication
(10) Pub. No.: US 2009/0149080 A1
(43) Pub. Date: Jun. 11, 2009

(54) Audio jack connector

(75) Inventor: Chun-Kwan Wu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/316,091

(22) Filed: Dec. 8, 2008

(30) Foreign Application Priority Data
Dec. 6, 2007 (CN) 200720131274.X

(51) Int. Cl. H01R 24/04; H01R 13/02

(52) U.S. Cl. 439/668; 439/884

(57) ABSTRACT

An audio jack connector in accordance with a preferred embodiment of the present invention is provided. The audio jack connector at least comprises an insulative housing with at least a terminal contact, wherein the insulative housing defines an insert hole through which a plug inserted and contacted with the terminal contact. The terminal contact at least includes a base portion, a tail portion and an elastic portion. Wherein, the elastic portion includes a first cured portion extending from an upper edge of the base portion towards a center of the insert hole and a second cured portion extending slantly and sideward from a side edge of the first cured portion.

### BACKGROUND OF THE INVENTION

1. Field of the Invention

The present invention relates to an electrical connector, and more particularly to an audio jack connector at least including a plurality of terminal contacts mounted onto a mobile phone. Wherein, the terminal contacts are arranged side-by-side and having a first elastic portion and a second elastic portion extending from a side edge of the first elastic portion.

2. Description of the Related Art

Audio jack connector is widely used in a mobile phone and adapted for electrically connecting an audio jack and a printed circuit board. Generally, the audio jack connector at least comprises an insulative housing in which a plurality of terminal contacts are retained. It is well know for any skilled person in the art that the retaining relationship between the contacts and the insulative housing is a key factor. However, with the development of society and improvement demands of the consumer, the dimension of the mobile phone is more and more smaller. Correspondingly, the dimension of the audio jack connector is required to be smaller.

U.S. Pat. No. 5,919,052, filed on Jan. 8, 1998, and issued on Jul. 6, 1999, and entitled “Earphone Jack”, discloses an audio jack connector. The audio jack connector includes a plurality of terminal contacts mounted in a casing. The insulative housing at least includes four side walls and an insert hole. The terminal contacts are disposed on two opposite sides of the side walls. Each of the terminal contacts at least includes a contact engaging portion extending toward a central of the insert hole and adapted for engaging with a plug, and a solder portion extending outwardly from a bottom surface of the insulative housing adapted for mounting onto a printed circuit board. Wherein, the solder portions are coplanar with each other so as to mount onto the printed circuit board. While, the contact engaging portions of each terminal contacts extend along a different direction, especially adjacent terminal contacts which disposed on the same side. Therefore, there has a potential risk that every two adjacent contact engaging portion collides with each other. Furthermore, since each direction along which the contact engaging portion extends is different, the configuration of each contact is different; therefore, there need several stamping processes corresponding to each terminal contact. Thus, it also increases the expending of manufactory.

### BRIEF SUMMARY OF THE INVENTION

It is an object of the present invention to provide an audio jack connector which can save the space of the electrical connector and satisfied the trend of miniaturization.

In order to achieve the objective above, an audio jack connector in accordance with a preferred embodiment of the present invention is provided. The audio jack connector at least comprises an insulative housing with at least a terminal contact, wherein the insulative housing defines an insert hole through which a plug inserted and contacted with the terminal contact. The terminal contact at least includes a base portion, a tail portion and an elastic portion. Wherein, the elastic portion includes a first cured portion extending from an upper edge of the base portion towards a center of the insert hole and a second cured portion extending slantly and sideward from a side edge of the first cured portion. Therefore, said terminal contact do not occupy much space of the electrical connector, thereby it is satisfied the trend of miniaturization. Furthermore, since the elastic portion includes a first and second cured portion, the length of the elastic portion is increased such that a well and reliable elastic property is provided.

In order to achieve the objective stated above, a contact in accordance with a preferred embodiment of the present invention is provided. The contact includes a base portion extending uprightly, a tail portion extending horizontal from a bottom edge of the base portion, and an elastic portion extending upwardly and slantly from an upper edge of the base portion. Wherein, the elastic portion includes a first and second bent portion, the first bend portion extending from an upper edge of the base portion and far away from the base portion, and the second bend portion extending sideward from a side edge of the first bend portion.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like members in the figures and in which:

FIG. 1 is an exploded view of the audio jack connector according to the present invention;

FIG. 2 is another exploded view of the audio jack connector according to the present invention;

FIG. 3 is similar to FIG. 2, wherein a plug is inserted into the audio jack connector;

FIG. 4 is a perspective view of one of the terminal contacts;

FIG. 5 is a perspective view of an electrical connector of FIG. 1;

FIG. 6 is a cut view of FIG. 4 along a line 6-6;

### DESCRIPTION OF PREFERRED EMBODIMENT OF THE INVENTION

In the following detailed description, for purposes of explanation, numerous specific details are set forth in order to provide a thorough understanding of the present invention.

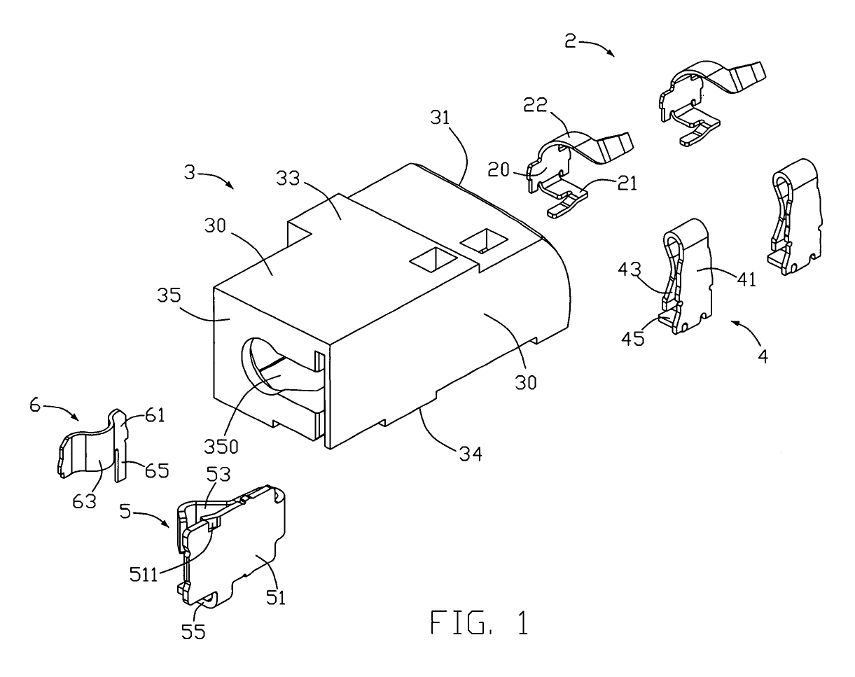

Please refer to FIG. 1 to FIG. 3, the audio jack connector according to the present invention comprises an insulative housing 3, a pair of first terminal contacts 2, a pair of second terminal contacts 4, a third terminal contact 5 and a fourth terminal contact 6.

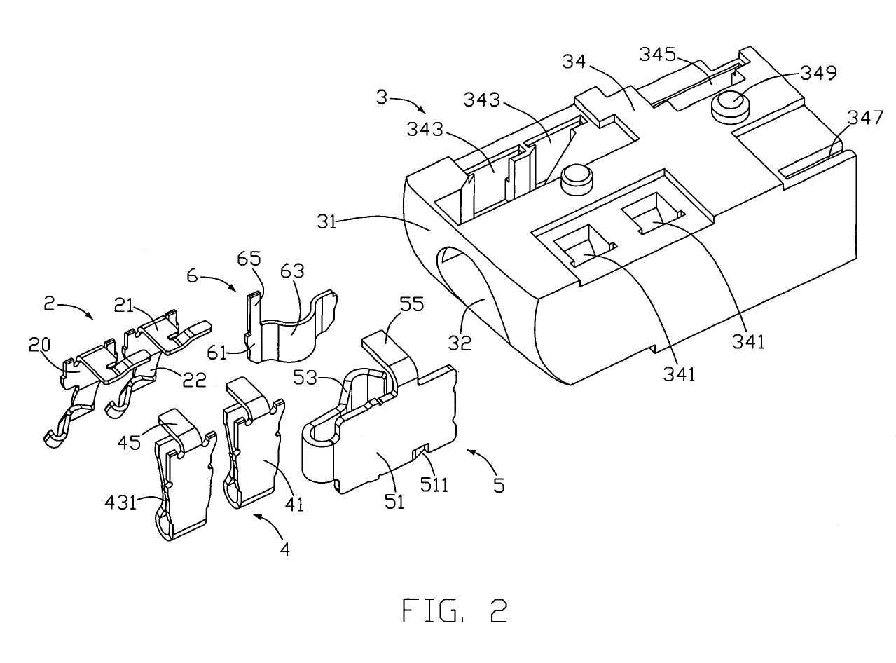

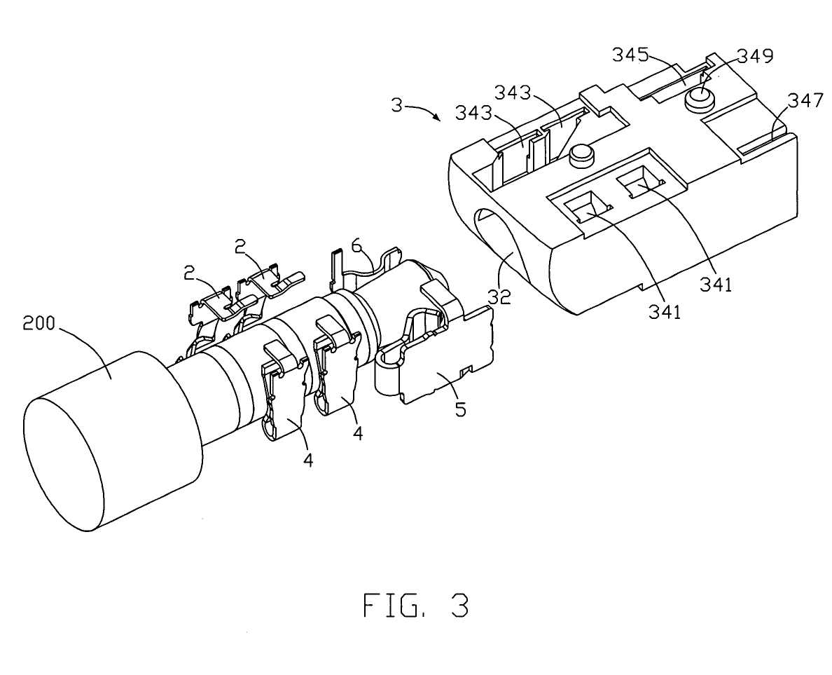

Please also refer to FIGS. 1-3, the insulative housing 3 includes a top surface 33, a mounting surface 34, a front surface 31, a rear surface 35, and two opposite side surfaces 30. Please particular refer to FIGS. 2-3, an insert hole 32 is defined on the front surface 31 and penetrating the rear surface 35. The mounting surface 34 defines a pair of first slots 343 for retaining the first terminal contacts 2, a pair of second slots 341 for retaining the second terminal contacts 4, a third slot 347 for receiving the third terminal contact 5 and a fourth slot 345 for receiving the fourth terminal contact 6. Wherein, the first slots 343 and the fourth slot 345 are opposite to the second and third slots 341, 347, and the first and second slots 343, 341 are adjacent to the front surface 31 and the third and fourth slots 345, 347 are adjacent to the rear surface 35. The second slot 341 passes through the top surface 33. Additionally, the rear surface 35 defines a round hole 350 communicates with the insert hole 32 along an inserting direction and communicates with the fourth slot 347 along a second direction perpendicular to the inserting direction. Moreover, a pair of posts 349 are defined on the mounting surface 34 and extending perpendicular beyond the mounting surface 34 adapted for interconnecting with the printed circuit board.

Please refer to FIGS. 1-6, each of the first terminal contact 2 includes a first base portion 20 extending uprightly, a first tail portion 21 extending horizontal from a bottom edge of the first base portion 20 and a first elastic portion 22 extending slantly and upwardly from an upper edge of the first base portion 20 to a center of the insert hole 32. The first tail portion 22 is perpendicular to the first base portion 20 and includes a horizontal plate portion 211 interconnected with the first base portion 20 and a solder portion 210 vertical to said horizontal plate portion 211 and extending slantly downward from a distal end of the horizontal plate portion 211. Wherein, the horizontal plate portion 211 defines a first top surface (not labeled) parallel to a second top surface (not labeled) defined on said solder portion 210, and the horizontal plate portion 211 is not coplanar with the solder portion 210.

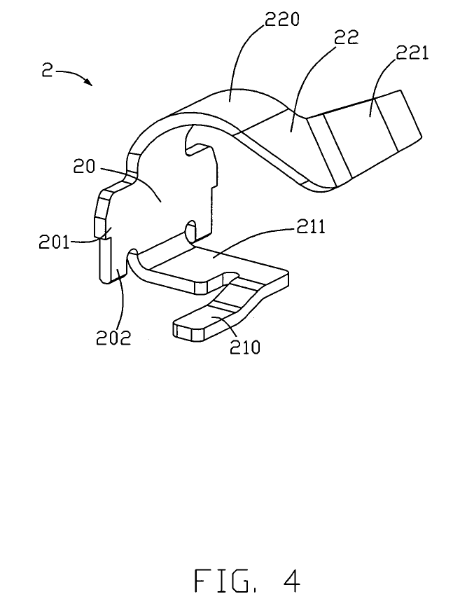

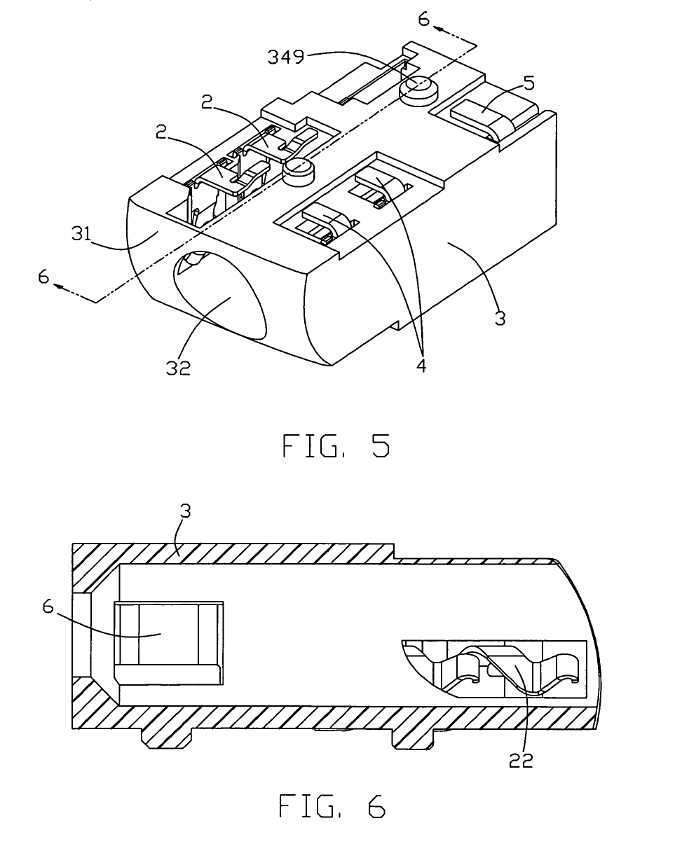

Please particular refer to FIG. 4 and FIG. 6, the first elastic portion 22 includes a first cured portion 220 and a second cured portion 221, wherein the first cured portion 220 extends upwardly from the upper edge of the first base portion 20 and the second cured portion 221 extends slantly from a side edge of the first cured portion 220 and angled with the first cured portion 220. The angle formed by first and second cured portion 220, 221 is more than 90 degree. Additionally, the first cured portion 220 disposed above the horizontal plate portion 211 and the second cured portion 221 extends sideward from a side edge of the first cured portion 220, such that a projection of the first cured portion 220 is overlapped with a projection of the first tail portion 22, and a projection of the second cured portion 221 is adjacent to the projection of the first tail portion 22. Therefore, on one hand, because the first elastic portion 22 includes a first and second elastic portion 220, 221, the length of the first elastic portion 22 is increased and a well elastic property is supplied, and on the other hand, because the second cured portion 221 extends sideward from a side edge of the first cured portion 220, the pair of first terminal contacts will not contact with each other when a plug is inserted.

The second terminal contacts 4, each including a second base portion 41, a second tail portion 45 extending horizontal from a bottom edge of the second base portion, and a second elastic portion 43 extending downwardly from an upper edge of the second base portion 41. The second elastic portion 43 defines a contact engaging surface 431 in the middle thereof so as to engaging with a corresponding portion of the plug 200, wherein the contact engaging surface 431 firstly protruding toward the second base portion 41, then protruding far away the second base portion 41.

The third terminal contact 5 includes a third base portion 51, a third elastic portion 53 extending from a side edge of the third base portion 51 to an other side edge thereof, and a third tail portion 55 extending horizontal from a bottom edge of the third base portion 51. The third base portion 51 defines a tear portion (not labeled) disposed on the upper edge thereof and adapted for engaging with the insulative housing 3.

The fourth terminal contact 6 includes a fourth base portion 61, a fourth elastic portion 63 extending frontward from a side edge of the fourth base portion 61, and a fourth tail portion 65 extending downward from a bottom edge of the fourth base portion 61. Please particular to refer to FIG. 6, the middle of the fourth elastic portion 63 exposures in the insert hole 23, and the distal end thereof is retained into the fourth slot 349.

When the terminal contacts 2, 4, 5, 6 are assembled into the insulative housing 3 from the mounting surface 34, please particular refer to FIG. 6, the first elastic portion 22, the second elastic portion 43, the third elastic portion 53, and the fourth elastic portion 63 are exposed into the insert hole 32, an the first tail portion 21, the second tail portion 45, the third tail portion 55, and the fourth tail portion 65 extend outward from the mounting surface 34 of the insulative housing 3 adapted for electrically interconnecting with a conductive pads formed on the printed circuit board. Wherein, the two first terminal contacts 2 are arranged in the insulative housing 3 side-by-side, and the two second terminal contacts 4 is similar to said first terminal, also arranged side-by-side. Because the two first terminal contact 2 is equivalent to each other and arranges side-by-side, when a plug 200 is inserted into the insert hole 32 and contacts with the first terminal contacts 2, it is impossible that the first elastic portion 22 are contacted with each other.

In the above description of the preferred embodiment, the audio jack connector at least comprises two first terminal contacts, which arranges side-by-side and a first elastic portion formed on the first terminal contact includes a first a cured portion extending from an upper edge of the first base portion toward the center of the insert hole and a second cured portion extending from a side edge of the first cured portion. Therefore, on one hand, the length of the first elastic portion is increased such that a well and reliable elastic property is provided; on the other hand, the second cured portion extends from a side edge of the first cured portion such that it fails to occupy much space such that it can reduce the dimension of the electrical connector and satisfy the trend of miniaturization.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An audio jack connector comprising:
an insulative housing with an insert hole;
a plurality of terminal contacts at least having a first terminal contact;
the first terminal contact including a base portion retained into the insulative housing and an elastic portion extending toward to a center of the insert hole, the elastic portion including a first cured portion and a second cured portion; wherein
the first cured portion extends from an upper edge of the base portion to the center of the insert hole, and the second cured portion extends from a side edge of the first cured portion to sideward.

2. The audio jack connector as recited in claim 1, wherein the second cured portion defines an engaging portion adapted for engaging with a plug inserted into the insert hole of the insulative housing.

3. The audio jack connector as recited in claim 2, wherein a projection of the first cured portion is overlapped with that of the tail portion and the projection of the second cured portion is disposed on a position adjacent to the tail portion.

4. The audio jack connector as recited in claim 1, wherein the tail portion at least includes a board portion interconnected with the base portion and a spring solder pad extending perpendicular from a distal end of the board portion.

5. The audio jack connector as recited in claim 4, wherein the spring solder pad defines a first top surface and the board portion defines a second top surface, wherein the first top surface is parallel to the second top surface, but the first top surface is not coplanar with the second top surface.

6. The audio jack connector as recited in claim 1, wherein the insulative housing at least includes a top surface, a mounting surface, a front surface, a rear surface and two opposite side surfaces, wherein the rear surface defines a round hole passing through the insert hole, and a third slot for receiving a third terminal contact is defined on the mounting surface, and the third slot penetrated the third slot.

7. The audio jack connector as recited in claim 1, wherein the terminal contact further includes another contact which has a same configure with the first terminal contact and arranged adjacent to the first terminal contact.

8. A contact including:
a base portion extending along an upright direction;
a tail portion extending horizontal from a bottom edge of the base portion;
an elastic portion extending upwardly from an upper edge of the base; wherein
the elastic portion includes a first bend portion interconnected with the base portion and a second bend portion extending sideward from a side edge of the first bend portion.

9. The contact as recited in claim 8, wherein the second bend portion defines a contact engaging portion.

10. The contact as recited in claim 8, wherein the first and second bend portion forms an angle.

11. The contact as recited in claim 10, wherein the angle formed by the first and second bend is more than 90 degree.

12. The audio jack connector as recited in claim 8, wherein the first bend portion disposed above the tail portion and the second bend portion extends slant and upwardly from a side edge of the first bend portion.

13. The audio jack connector as recited in claim 8, wherein the tail portion at least includes a horizontal plate portion which interconnected with the base portion and a solder portion perpendicular to the horizontal plate portion.

14. The audio jack connector as recited in claim 13, wherein the solder portion extends slantly and downward from the distal end of the horizontal plate.

15. An electrical connector for use with an inserted plug, comprising:
an insulative housing defining a columnar plug receiving hole extending along an axial direction, and at least two neighboring contact receiving passageways located on one side of the plug receiving hole and being open to an bottom face of the housing and in communication with the plug receiving hole; and
first and second contacts respectively disposed in the corresponding contact receiving passageways, each of said contacts defining a vertical retention section, a horizontal soldering section extending from a lower portion of the retention, and an elastic section extending from an upper portion of the retention section, wherein
the elastic section includes a first curved portion linked to the retention section, and a second curved portion linked to a distal end of the first curved portion with a contact point thereof, under condition that said first curved portion and said second curved portion are convex with regard to the inserted plug while a joint between said first curved portion and said second curved portion is concave.

16. The electrical connector as claimed in claim 15, wherein said elastic section extends in an oblique direction with regard to the axial direction in a top view.

17. The electrical connector as claimed in claim 15, wherein the contact point of the second contact is located right above the soldering section of the first contact.

18. The electrical connector as claimed in claim 17, wherein the second contact is located behind the first contact in said axial direction.

19. The electrical connector as claimed in claim 17, further including third and fourth contacts located on the other side of the plug receiving hole, wherein each of the first contact and the second contact is of an offset manner between the contact point and the soldering section while those of said third contact and said fourth contacts are not.
